(19) United States
(12) Patent Application Publication
(10) Pub. No.: US 2009/0282953 A1
(43) Pub. Date: Nov. 19, 2009

(54) HAND TOOL ASSEMBLY

(76) Inventor: Ya-Ling Lin, Taichung City (TW)

Correspondence Address: Chien-Hui Su, P. O. Box 70-121 Taichung, Taichung City, 40899, TW

(21) Appl. No.: 12/122,728

(22) Filed: May 19, 2008

(51) Int. Cl. B25B 13/14; B25B 13/46; B25B 13/06

(52) U.S. Cl. 81/165; 81/60; 81/121.1

(57) ABSTRACT

A hand tool includes a wrench having a shank. A first mechanism has an adjustable head formed on a first end of the shank. The first mechanism includes a fixed jaw extending from the adjustable head, a movable jaw mounted in the adjustable head, and a worm gear mounted in the adjustable head. A second mechanism has a ratchet head is formed on a second end of the shank and the second mechanism includes a ratchet unit centrally mounted in ratchet head, a through hole centrally defined in the ratchet unit, a series of teeth equidistantly formed on an inner periphery of the through hole, and a connecting unit partially detachably received in the through hole.

### BACKGROUND OF THE INVENTION

1. Field of the Invention

The present invention relates to a hand tool assembly, and more particularly to a hand tool assembly that is suitable to sockets with various standards.

2. Description of Related Art

A conventional hand tool in accordance with the prior art comprises a first end formed as an adjustable wrench and a second end formed as a ratchet wrench. The adjustable wrench has a fixed jaw integrally extending therefrom and a movable jaw adjustably mounted on the adjustable wrench to be moved relative to the fixed jaw. The ratchet wrench has a ratchet mounted therein and a ratchet hole is centrally formed in the ratchet for driving a bolt, a fastener, or a workpiece.

However, an inner diameter of the ratchet hole is immovable. The ratchet hole of the ratchet wrench only can be used to one size of the bolt, the fastener, or the workpiece. As a result, the use scope of the conventional hand tool is limited.

The present invention has arisen to mitigate and/or obviate the disadvantages of the conventional hand tool.

### SUMMARY OF THE INVENTION

The main objective of the present invention is to provide an improved hand tool that has a connecting unit detachably mounted in a through hole of a ratchet unit for different work types.

To achieve the objective, the hand tool in accordance with the present invention comprises a wrench having a shank. A first mechanism has an adjustable head formed on a first end of the shank. The first mechanism includes a fixed jaw extending from the adjustable head, a movable jaw mounted in the adjustable head to be adjustably moved relative to the fixed jaw, and a worm gear rotatably mounted in the adjustable head for engaging with the movable jaw to adjust the distance between the fixed jaw and the movable jaw. A second mechanism has a ratchet head formed on a second end of the shank. The second mechanism includes a ratchet unit centrally mounted in the ratchet head, a through hole centrally defined in the ratchet unit, a series of teeth equidistantly formed on an inner periphery of the through hole, and a connecting unit partially detachably received in the through hole. According to the present invention, the second mechanism further comprises multiple driving units. Each of the driving units is detachably connected to the connecting unit and each driving units has a different standard to be adapted to different work types.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a hand tool assembly in accordance with the present invention;

FIG. 2 is a perspective view of the hand tool assembly in accordance with the present invention;

FIG. 3 is a perspective schematic view of the hand tool assembly in accordance with the present invention when being collected in a tool box;

FIG. 4 is an operational view of the hand tool assembly in FIG. 2;

FIG. 5 is an exploded perspective view of a second embodiment of the hand tool assembly in accordance with the present invention; and

FIG. 6 is a perspective view of the second embodiment of the hand tool assembly in accordance with the present invention.

### DETAILED DESCRIPTION OF THE INVENTION

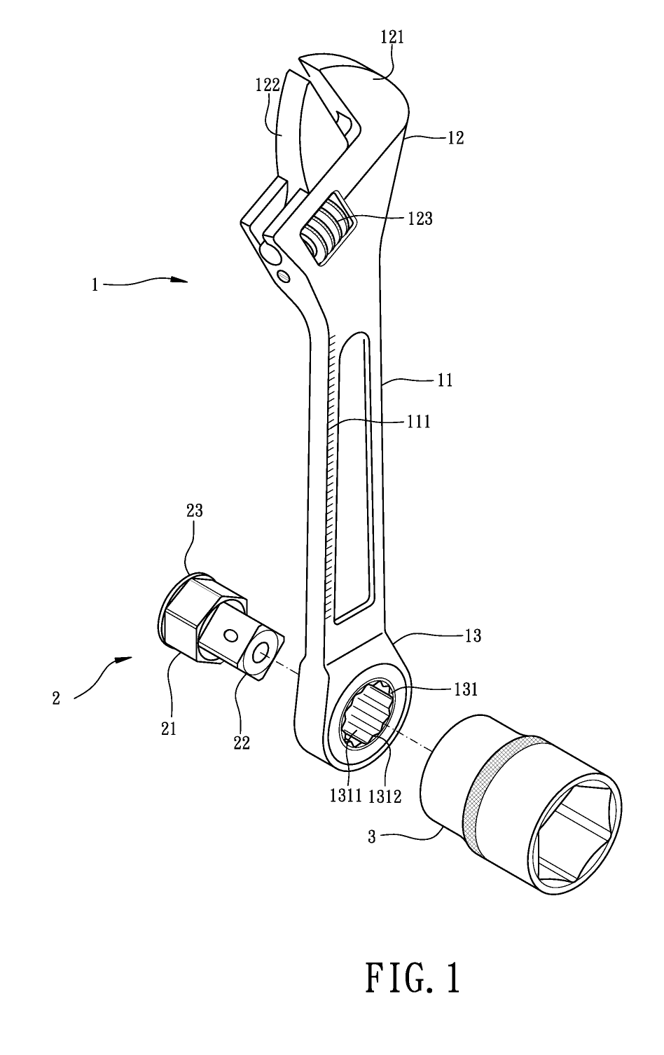

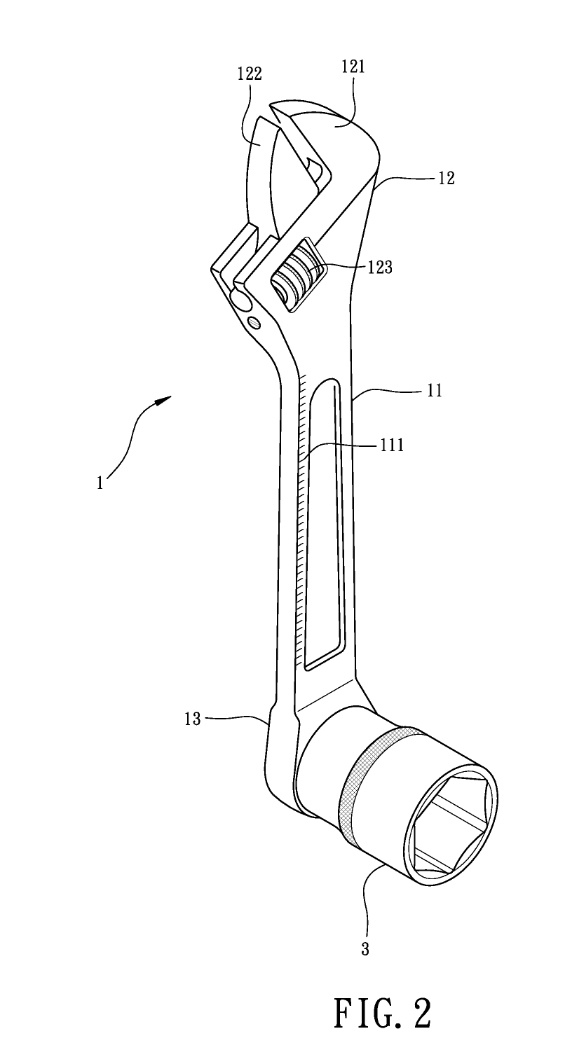

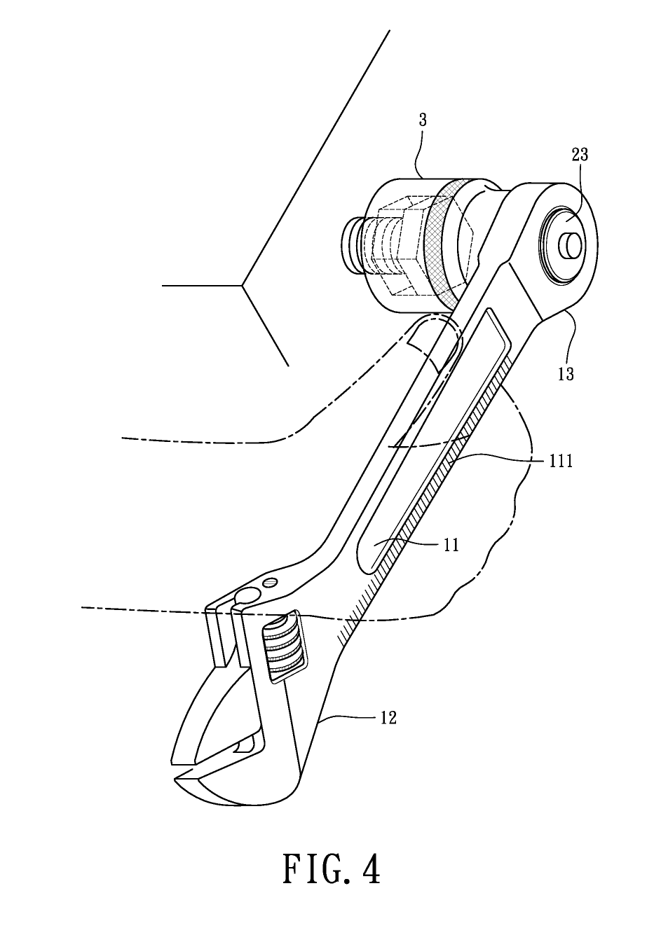

Referring to the drawings and initially to FIGS. 1-4 of a first embodiment, a hand tool assembly in accordance with the present invention comprises a wrench (1) having a shank (11) having a first end and a second end. The shank (11) has a series of scales (111) formed on one side thereof for measuring a size of a workpiece.

A first mechanism has an adjustable head (12) formed on the first end of the shank (11). A fixed jaw (121) extends form the adjustable head (12) and a movable jaw (122) is mounted in the adjustable head (12) to be adjustably moved relative to the fixed jaw (121). A worm gear (123) is rotatably mounted in the adjustable head (12) and engages with the movable jaw (122) for driving the movable jaw (122) to adjust the distance between the fixed jaw (121) and the movable jaw (122).

A second mechanism has a ratchet head (13) formed on the second end of the shank (11). A ratchet unit (131) is centrally mounted in the ratchet head (13) and a through hole (1311) is centrally defined in the ratchet unit (131). A series of teeth (1312) is equidistantly formed on an inner periphery of the through hole (1311). A connecting unit (2) is partially and detachably received in the through hole (1311). In this embodiment, the connecting unit (2) includes an insertion portion (21) received in the through hole (1311) and engaged with the series of teeth (1312) such that the connecting unit (2) is rotated with the ratchet unit (131), a shoulder (23) radially extending from a first end of the insertion portion (21) to prevent the connecting unit (2) from overly extending through the through hole (1311) and a driving portion (22) longitudinally and centrally extending from a second end of the insertion portion (21).

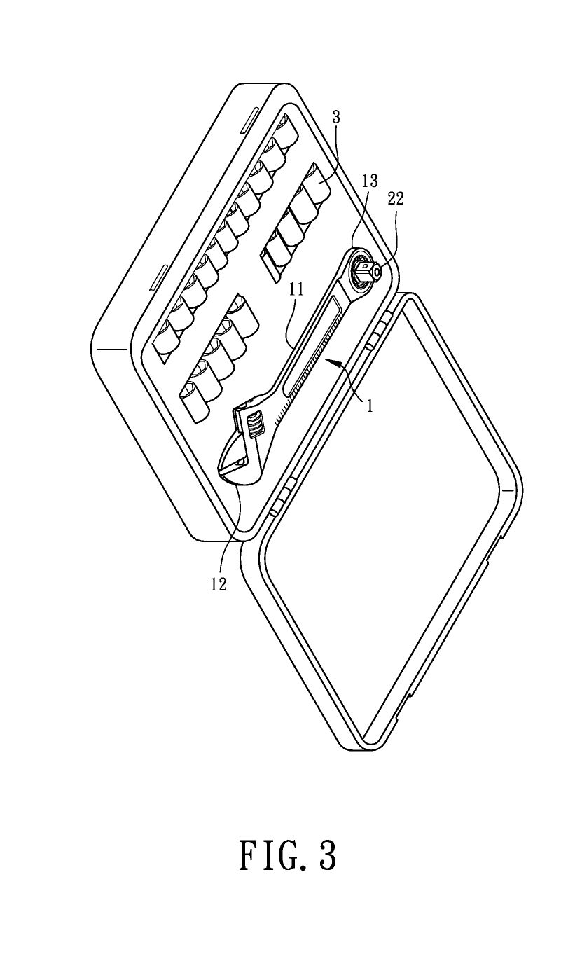

Multiple driving units (3) each has a different standard adapted to different work types as shown in FIG. 3. Each driving units (3) has a first end and second end. The driving portion (22) of the connecting unit (2) is detachably mounted in the first end of the each driving units (3). The second end of the each driving units (3) is adapted to sleeve on the workpiece.

Wherein the connecting unit (2), ratchet unit (131), and a corresponding one of the driving units (3) are concentrically simultaneously rotated by the wrench (1) for providing a ratcheting function when the connecting unit (2) is partially received in the through hole (1311) and the driving portion (22) of the connecting unit (2) is mounted in the first end of each of the driving units (3).

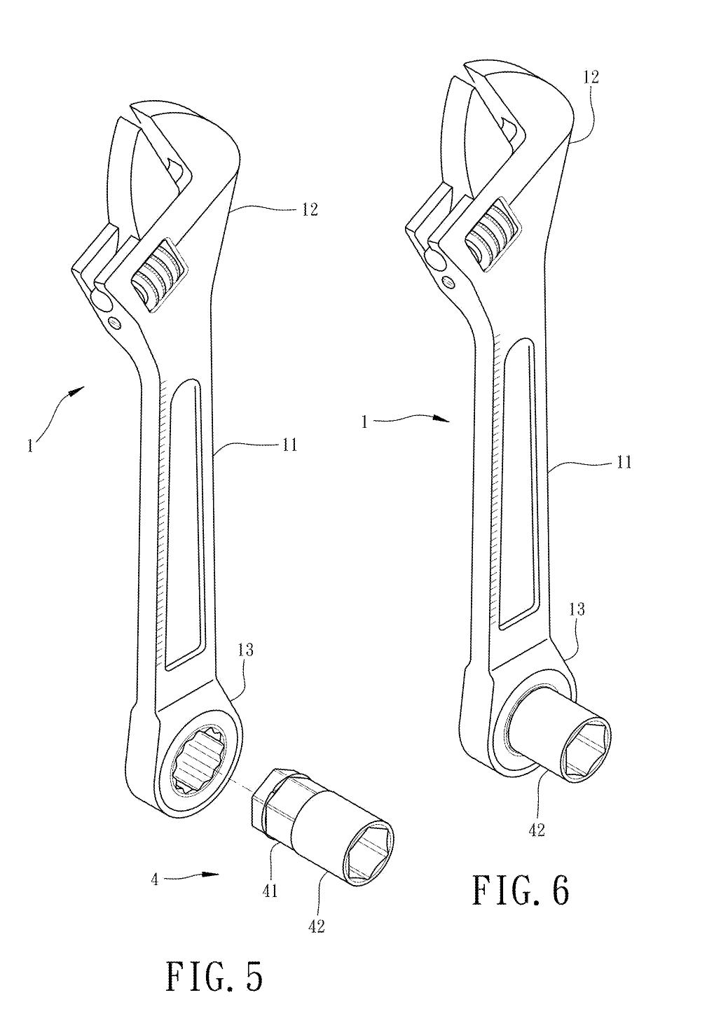

FIG. 5 and FIG. 6 show a second embodiment of the present invention. In this embodiment, a connecting unit (4) has an insertion portion (41) formed on a first end of the connecting unit (4) and detachably received in the through hole (1311) and a driving portion (42) extending from the insertion portion (41). The driving portion (42) has a polygonal hole defined therein and adapted to sleeve on the workpiece (not shown). The driving portion (42) has an outer diameter greater than the diameter of the through hole (1311) to prevent the connecting unit (4) from overly inserted into the through hole (1311).

Although the invention has been explained in relation to its preferred embodiment, it is to be understood that many other possible modifications and variations can be made without departing from the spirit and scope of the invention as hereinafter claimed.

1. A hand tool comprising:
a wrench having a shank having a series of scales fonned on one side thereof for providing a measuring effect;
a first mechanism having an adjustable head formed on a first end of the shank, the first mechanism including a fixed jaw extending from the adjustable head, a movable jaw mounted in the adjustable head to be adjustably moved relative to the fixed jaw, and a worm gear rotatably mounted in the adjustable head for engaging with the movable jaw to adjust the distance between the fixed jaw and the movable jaw; and
a second mechanism having a ratchet head formed on a second end of the shank, the second mechanism including a ratchet unit centrally mounted in the ratchet head, a through hole centrally defined in the ratchet unit, a series of teeth equidistantly formed on an inner periphery of the through hole, and a connecting unit partially detachably received in the through hole to be adapted to different work types, the connecting unit having an insertion portion received in the through hole and engaged with the series of teeth, a driving portion extending from the insertion portion for providing a connecting effect and having a polygonal hole defined therein for adapting to sleeve on the workpiece, the driving portion having an outer diameter greater than a diameter of the through hole to prevent the connecting unit from overly inserted into the through hole;
whereby, the connecting unit and the ratchet unit are concentrically simultaneously rotated by the wrench for providing a ratcheting function when the connecting unit is partially received in the through hole.

2. (canceled)

3. (canceled)

4. (canceled)

5. (canceled)

7. (canceled)

8. (canceled)

9. A hand tool comprising:
a wrench having a shank having a series of scales formed on one side thereof for providing a measuring effect;
a first mechanism having an adjustable head formed on a first end of the shank, the first mechanism including a fixed jaw extending from the adjustable head, a movable jaw mounted in the adjustable head to be adjustably moved relative to the fixed jaw, and a worm gear rotatably mounted in the adjustable head for engaging with the movable jaw to adjust the distance between the fixed jaw and the movable jaw;
a second mechanism having a ratchet head formed on a second end of the shank, the second mechanism including a ratchet unit centrally mounted in the ratchet head, a through hole centrally defined in the ratchet unit, a series of teeth equidistantly formed on an inner periphery of the through hole, and a connecting unit partially detachably received in the through hole to be adapted to different work types, the connecting unit having an insertion portion received in the through hole and engaged with the series of teeth, a driving portion longitudinally centrally extending from the insertion portion for providing a connecting effect, a shoulder radially extending form the connecting unit to prevent the connecting unit from overly extending through the through hole; and
multiple driving units respectively detachably connected to the insertion portion of the connecting unit and each driving unit having a different standard for adapting to different work types;
whereby, the connecting unit and the ratchet unit are concentrically simultaneously rotated by the wrench for providing a ratcheting function when the connecting unit is partially received in the through hole.
